(19) United States
(12) Patent Application Publication
(10) Pub. No.: US 2016/0250642 A1
(43) Pub. Date: Sep. 1, 2016

(54) METHOD AND SYSTEM FOR CONTROLLING A JAW CRUSHER

(71) Applicant: SANDVIK INTELLECTUAL PROPERTY AB, Sandviken (SE)

(72) Inventor: Anders LINDSTRÖM, Svedala (SE)

(21) Appl. No.: 15/033,188

(22) PCT Filed: Oct. 7, 2014
(86) PCT No.: PCT/EP2014/071420

§ 371 Date: Apr. 29, 2016

(30) Foreign Application Priority Data
Nov. 1, 2013 (EP) 13191229.7

(51) Int. Cl. B02C 1/02; B02C 25/00

(52) U.S. Cl. CPC B02C 1/025; B02C 25/00

(57) ABSTRACT

A jaw crusher control system is arranged to control a hydraulic positioning device for positioning a movable jaw of a jaw crusher of the type comprising a movable jaw and a stationary jaw forming between them an outlet of a variable crushing chamber. The jaw crusher control system receives a signal from a crushing chamber level detector indicating the amount of material that is present in the crushing chamber and to control the hydraulic positioning device to position the movable jaw to obtain a first closed side setting (CSS1) when the crushing chamber is considered as full of material, and to obtain a second closed side setting when the crushing chamber is considered as empty of material, wherein in the second closed side setting (CSS2) the outlet is more narrow than in the first closed side setting (CSS1)

### TECHNICAL FIELD OF THE INVENTION

The present invention relates to a jaw crusher control system for controlling a hydraulic positioning device arranged for positioning a movable jaw of a jaw crusher of the type comprising a movable jaw and a stationary jaw forming between them a variable crushing chamber.

The present invention further relates to a jaw crusher, a crushing system, and a method of crushing material.

### BACKGROUND OF THE INVENTION

Jaw crushers are utilized in many applications for crushing hard material, such as pieces of rock, ore, etc. A jaw crusher has a movable jaw that cooperates with a stationary jaw. Between the jaws a crushing chamber is formed.

EP 2 564 928 discloses a jaw crusher having a hydraulic positioning device for positioning a movable jaw to a desired position. For instance, the hydraulic positioning device can be used to adjust the position of the movable jaw to compensate for wear of the wear plates against which material is crushed. Furthermore, the hydraulic positioning device may also be used for adjusting the position of the movable jaw to adapt the jaw crusher for crushing various types of materials, and to obtain various average sizes of the crushed material.

### SUMMARY OF THE INVENTION

An object of the present invention is to provide a jaw crusher control system which is more efficient for controlling a jaw crusher compared to the prior art control systems.

This object is achieved by means of a jaw crusher control system for controlling a hydraulic positioning device arranged for positioning a movable jaw of a jaw crusher of the type comprising a movable jaw and a stationary jaw forming between them a variable crushing chamber, wherein the jaw crusher control system is adapted to receive a signal from a crushing chamber level detector indicating the amount of material that is present in the crushing chamber and to control the hydraulic positioning device to position the movable jaw to obtain a first closed side setting when the crushing chamber is considered as full of material, and to obtain a second closed side setting when the crushing chamber is considered as empty of material, wherein the second closed side setting is more narrow than the first closed side setting.

An advantage of this jaw crusher control system is that a better control of the size of the crushed material is obtained. When the crushing chamber is full of material the crushing chamber is operated with the relatively wide first closed side setting, which increases the crushing capacity of the jaw crusher. Due to the substantial autogenic crushing occurring in such full crushing chamber the crushed material leaving the crushing chamber will have a relatively small maximum particle size. On the other hand, when the crushing chamber is empty or at least relatively empty of material the crushing chamber is operated with the relatively narrow second closed side setting to compensate for the quite limited autogenic crushing at such conditions. This decreases the risk that large objects pass through the crushing chamber without being crushed. Thereby, the output material of the crushing chamber will have a relatively constant particle size, regardless of whether the crusher operates with a full crushing chamber and a large autogenic crushing or with an empty crushing chamber and a small, or no, autogenic crushing.

According to one embodiment the jaw crusher control system is adapted to compare the signal received from the crushing chamber level detector to a crushing chamber level set point and to determine, based on said comparison, whether the crushing chamber is to be considered as full or empty of material. An advantage of this embodiment is that the jaw crusher control system operates in a predictable manner when the shift from the first to the second closed side setting is based on a comparison to a crushing chamber level set point.

According to one embodiment the jaw crusher control system is adapted to receive the signal from a crushing chamber level detector in the form of a level sensor. An advantage of this embodiment is that a level sensor provides an accurate and relevant indication of the amount of material that is present in the jaw crusher crushing chamber. The level sensor may, for example, be an ultrasonic sensor, a radar sensor, a laser sensor, or a camera utilizing image analysis for analyzing the level of material that is present in the crushing chamber. These types of sensors provide an accurate and reliable measurement of the level of material present in the crushing chamber.

According to one embodiment the jaw crusher control system is adapted to receive the signal from a crushing chamber level detector in the form of a jaw crusher motor. An advantage of this embodiment is that the power drawn by the jaw crusher motor provides an indirect indication of the amount of material that is present in the jaw crusher crushing chamber. The power drawn by the motor is also independent from such things as dust clouds etc. that may under some circumstances obscure the measurement precision of, for example, optical level meters.

According to one embodiment the jaw crusher control system is adapted to receive signals both from a crushing chamber level detector in the form of a level sensor and from a crushing chamber level detector in the form of a jaw crusher motor and to determine the present amount of material in the crushing chamber from both signals. An advantage of this embodiment is that an extra reliable determination of the amount of material present in the crushing chamber is obtained.

According to one embodiment the second closed side setting CSS2 is 30-90%, more preferably 40-80%, of the first closed side setting CSS1. These ranges for the second closed side setting CSS2 have proven to provide for efficient crushing and yet a low risk that large pieces of material pass through the crushing chamber in an unwanted manner when the crushing chamber is empty.

According to one embodiment the jaw crusher control system is adapted to control the hydraulic positioning device to position the movable jaw to the first or second closed side setting during operation of the jaw crusher. An advantage of this embodiment is that crushing operation is made more efficient when control of the movable jaw is performed during operation of the crusher, and when the crushing operation does not have to be stopped at all.

A further object of the present invention is to provide a jaw crusher which is more efficient in crushing material than the previously known jaw crushers. This object is achieved by means of a jaw crusher comprising a movable jaw and a stationary jaw forming between them a variable crushing chamber, the jaw crusher further comprising a jaw crusher control system as described hereinabove. An advantage of this jaw crusher is that crushing of material becomes more efficient, since the closed side setting of the crushing chamber is controlled to that setting which is suitable in view of the amount of material that is present in the crushing chamber.

A still further object of the present invention is to provide a crushing system which is more efficient in crushing material than the previously known crushing systems. This object is achieved by means of jaw crusher as described hereinabove, a secondary treatment device, and a transporting device arranged to transport material that has been crushed in the jaw crusher to the secondary treatment device for being further treated. An advantage of this crushing system is that the jaw crusher is arranged for producing a relatively constant maximum size of the crushed material, regardless of the amount of material that is present in the jaw crusher crushing chamber. Thereby, the secondary treatment device can be designed for a well-defined maximum size of the material being supplied thereto from the jaw crusher, which makes the secondary treatment device efficient in treating the material. The secondary treatment device may, for example, be a secondary crusher, such as a gyratory crusher, an impact crusher or a mill, or could be another secondary treatment device, such as a sieve.

Another object of the present invention is to provide a method of crushing material which is more efficient than the known methods of crushing material.

This object is achieved by means of a method of crushing material, comprising the steps of

measuring an amount of material that is present in a crushing chamber of a jaw crusher,

determining whether the crushing chamber of the jaw crusher is to be considered as full or empty with material to be crushed,

controlling, when the crushing chamber has been determined to be considered as full, the position of a movable jaw of the jaw crusher to obtain a first closed side setting, and

controlling, when the crushing chamber has been determined to be considered as empty, the position of a movable jaw of the jaw crusher to obtain a second closed side setting, wherein the second closed side setting is more narrow than the first closed side setting.

An advantage of this method is that material can be crushed more efficiently. Furthermore, the risk is reduced that pieces of material having a too large size is forwarded to a following secondary treatment device, e.g., to a gyratory crusher.

According to one embodiment the method further comprises measuring the amount of material that is present in the jaw crusher crushing chamber by means of a level sensor and/or by measuring a power drawn by a jaw crusher motor, and/or by combining measuring by a level sensor and measuring the power drawn by a jaw crusher motor.

According to one embodiment the method further comprises determining whether the crushing chamber of the jaw crusher is to be considered as full or empty with material to be crushed by comparing the measured amount of material present in the crushing chamber of the jaw crusher to a first set point, wherein the crushing chamber is considered to be full if the measured amount of material is higher than the first set point, and the crushing chamber is considered to be empty if the measured amount of material is lower than the first set point. An advantage of this embodiment is that a repeatable and reliable control of the jaw crusher is obtained.

According to one embodiment the method further comprises comparing the measured amount of material in the crushing chamber of the jaw crusher to a first set point and to a second set point, wherein, if the measured amount of material is higher than the first set point, the crushing chamber is considered as full and the closed side setting is controlled to the first closed side setting, if the measured amount of material is lower than the second set point, then the crushing chamber is considered as empty and the closed side setting is controlled to the second closed side setting, and if the measured amount of material is lower than the first set point but higher than the second set point, then the closed side setting is controlled to an intermediate third closed side setting, which is narrower than the first closed side setting, but wider than the second closed side setting. An advantage of this embodiment is that the jaw crusher can be controlled more accurately, and will operate more efficiently when there is an intermediate amount of material present in the crushing chamber.

According to one embodiment the controlling of the position of a movable jaw of the jaw crusher to obtain the first or the second closed side setting is performed automatically and during operation of the jaw crusher. An advantage of this embodiment is that crushing of material becomes very efficient since it is not necessary to stop crushing for adjustment of the closed side setting or to involve manual supervision in the control of the crushing process.

According to one embodiment the closed side setting of the crushing chamber is controlled to be gradually widened in relation to an increasing amount of material present in the crushing chamber. An advantage of this embodiment is that the crushing in the jaw crusher may be performed at a high efficiency when the closed side setting is controlled to be optimum in relation to the present amount of material in the crushing chamber. In accordance with one embodiment the closed side setting is controlled to depend from the level of material in the crushing chamber, for example according to an equation describing a relation between present amount of material in the crushing chamber and a suitable corresponding closed side setting. This provides for extra efficient crushing of material. According to one embodiment the closed side setting is proportional to the level of material in the crushing chamber.

According to one embodiment the crushing chamber of the jaw crusher is considered to be empty if the amount of material in the crushing chamber corresponds to a level of material in the crushing chamber which is less than 40%, and at least if the level is less than 20%, of the total height of the crushing chamber. Hence, if the level of material in the crushing chamber is, for example, 30% of the total height of the crushing chamber then the crushing chamber is preferably considered as empty, because the autogenic crushing may not be enough for obtaining the required size reduction of the material. In particular, if the level of material in the crushing chamber is, for example, only 10% of the total height of the crushing chamber then the crushing chamber is most preferably considered as empty, because the autogenic crushing is most probably not sufficient for obtaining the required size reduction of the material.

According to one embodiment the crushing chamber of the jaw crusher is considered to be full if the amount of material in the crushing chamber corresponds to a level of material in the crushing chamber which is equal to or more than 40%, and at least if the level is more than 60%, of the total height of the crushing chamber. Hence, if the level of material in the crushing chamber is, for example, 50% of the total height of the crushing chamber then the crushing chamber is preferably considered as full, because the autogenic crushing is likely to be sufficient for obtaining the required size reduction of the material. In particular, if the level of material in the crushing chamber is, for example, 75% of the total height of the crushing chamber then the crushing chamber is most preferably considered as full, because the autogenic crushing is almost certainly sufficient for obtaining the required size reduction of the material.

Further objects and features of the present invention will be apparent from the following detailed description and claims.

### BRIEF DESCRIPTION OF THE DRAWINGS

The invention is described in more detail below with reference to the appended drawings in which:

FIG. 1 is a schematic side view of a crushing system.

FIG. 2a is schematic side view, in cross-section, of a full crushing chamber of a jaw crusher.

FIG. 2b is a schematic side view, in cross-section, of an almost empty crushing chamber of a jaw crusher.

FIG. 3 is a schematic diagram illustrating a principle of controlling a jaw crusher.

### DESCRIPTION OF PREFERRED EMBODIMENTS

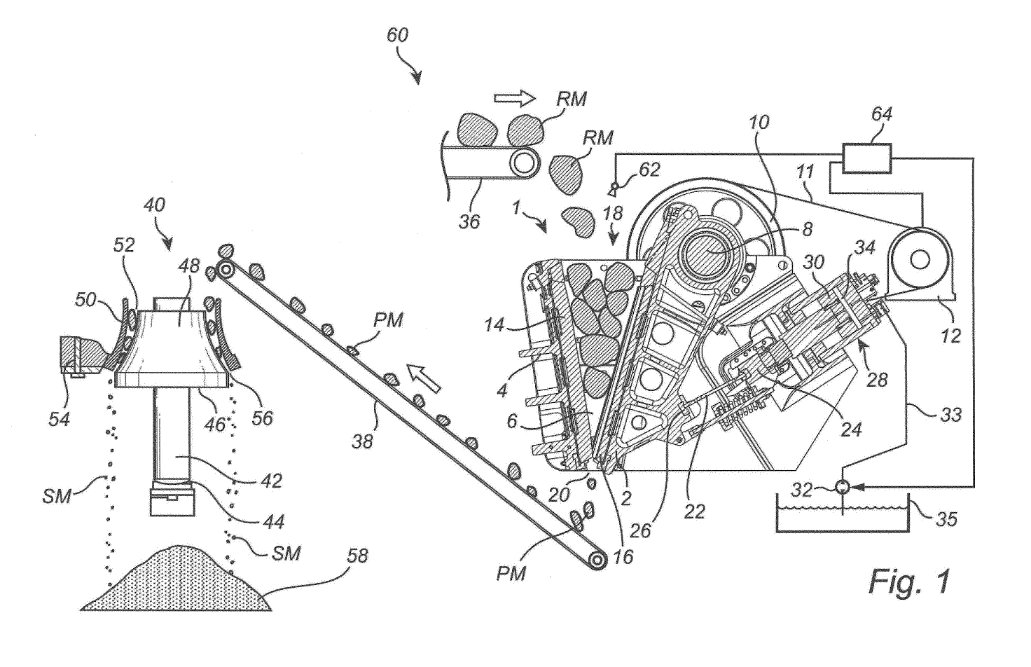

FIG. 1 illustrates, schematically, a jaw crusher 1. The jaw crusher 1 may be arranged to function as a primary crusher meaning that the jaw crusher 1 is the first crusher that acts on a raw material, for example pieces of rock obtained in a blast in a mine. Typically, objects having a largest size ranging from 100 to 1000 mm are to be crushed to smaller sizes in the jaw crusher 1. The jaw crusher 1 comprises a movable jaw 2 and a stationary jaw 4 forming between them a variable crushing chamber 6 of the jaw crusher 1. The movable jaw 2 is driven by an eccentric jaw crusher which causes the movable jaw 2 to move back and forth, up and down relative to the stationary jaw 4.

The inertia required to crush material fed to the jaw crusher 1 is provided by a weighted flywheel 10 operable to move the eccentric jaw crusher shaft 8 on which the movable jaw 2 is mounted. A jaw crusher motor 12 is operative for rotating the flywheel 10 by means of a transmission belt 11. The stationary jaw 4 is provided with a wear plate 14, and the movable jaw 2 is provided with a wear plate 16. The movement of the eccentric shaft 8 thus causes an eccentric motion of the movable jaw 2. Material to be crushed is fed to an intake 18 for material to be crushed. The crushed material leaves the jaw crusher 1 via an outlet 20 for material that has been crushed. The jaws 2, 4 are farther apart at the material intake 18 than at the material outlet 20, forming a tapered crushing chamber 6 so that the material is crushed progressively to smaller and smaller sizes as the material travels downward towards the outlet 20, until the material is small enough to escape from the material outlet 20 at the bottom of the crushing chamber 6.

The jaw crusher 1 comprises a toggle plate 22, a toggle beam 24, and a toggle plate seat 26 arranged at the lower end of the movable jaw 2. The jaw crusher 1 further comprises a hydraulic positioning device 28 for positioning the movable jaw 2 to a desired position, i.e. to a desired closed side setting. By “closed side setting” (CSS) is meant the shortest distance between the wear plate 14 of the stationary jaw 4 and the wear plate 16 of the movable jaw 2.

The hydraulic positioning device 28 comprises a hydraulically controlled piston 30 which acts on the toggle beam 24 and the toggle plate 22 to move, via the toggle plate seat 26, the lower end of the movable jaw 2 to the desired position, i.e. to the desired closed side setting, CSS. A hydraulic fluid pump 32 is arranged to pump hydraulic fluid to or from a hydraulic fluid cylinder 34 of the hydraulic positioning device 28. The hydraulic fluid pump 32 is connected to the hydraulic fluid cylinder 34 via a hydraulic fluid pipe 33, and supplies hydraulic fluid from, or returns hydraulic fluid to, a hydraulic fluid reservoir 35. The hydraulic fluid in the hydraulic fluid cylinder 34 acts on the hydraulically controlled piston 30 and moves the piston 30, and thereby the movable jaw 2, towards the stationary jaw 4 if hydraulic fluid is pumped into the hydraulic fluid cylinder 34, and moves the piston 30, and thereby the movable jaw 2, away from the stationary jaw 4 if hydraulic fluid is pumped out of the hydraulic fluid cylinder 34 by the pump 32.

A first transporting device, for a example a first material feeder, in this example a belt conveyor 36, is arranged for transporting raw material RM to be crushed to the crushing chamber 6 of the jaw crusher 1. The raw material RM may, for example, be material transported out of a mine after a blasting therein. Hence, the raw material RM may typically include pieces of rock having very uneven shapes and a large variation in shapes. For example, the pieces of raw material RM may have a largest size ranging from 100 to 1000 mm. The crushing action of the jaw crusher 1 reduces the size of the raw material RM and makes the material obtain a more rounded shape. A primarily crushed material PM leaves the crushing chamber 6 of the jaw crusher 1 at the outlet 20. The primarily crushed material PM may typically have a largest size ranging from 50 to 400 mm.

A second transporting device, for example a second material feeder, in this embodiment a belt conveyor 38, is arranged for transporting the primarily crushed material PM from the jaw crusher 1 to a secondary treatment device, which in this example embodiment is a secondary crusher in the form of a gyratory crusher 40, for further treating the primarily crushed material PM coming from the jaw crusher 1. By “further treating” is meant that at least one material property, such as particle size or particle size distribution, of the primarily crushed material PM is further changed by, for example, reducing the material to a smaller size, or classifying the material into different sizes. The secondary crusher, in this example embodiment the gyratory crusher 40, is the second crusher that acts on a raw material, for example pieces of rock obtained in a blast in a mine, and crushes a material that has already been crushed in the jaw crusher 1, functioning as a primary crusher, to even smaller sizes.

The gyratory crusher 40 has a gyratory crusher shaft 42. At its lower end 44 the crusher shaft 42 is eccentrically mounted. At its upper end the crusher shaft 42 carries a crushing head 46. A first crushing shell in the form of an inner shell 48 is mounted on the outside of the crushing head 46. A second crushing shell in the form of an outer shell 50 surrounds the inner shell 48. The inner shell 48 and the outer shell 50 define between them a crushing chamber 52 of the gyratory crusher 40. The width of the crushing chamber 52 in axial section decreases downwards, as shown in FIG. 1. The outer shell 50 is attached to a crusher frame 54, which is illustrated schematically in FIG. 1. The width of the crushing chamber 52, and in particular the size of the crushed material, can be adjusted, for example by raising and lowering the crusher shaft 42, and thus the crushing head 46 and the inner shell 48, for example by means of a hydraulic adjusting device (not shown). A motor (not shown) is arranged to cause the crusher shaft 42, and thereby the crushing head 46, to perform a gyratory pendulum movement during operation of the crusher, i.e. a movement during which both crushing shells 48, 50 approach one another along a rotating generatrix and move away from one another along a diametrically opposed generatrix. The primarily crushed material PM introduced in the crushing chamber 52 is crushed between the two shells 48, 50 and forms a secondarily crushed material SM that leaves the crushing chamber 52 via an outlet 56. The secondarily crushed material SM may typically have a largest size ranging from 20 to 100 mm. The secondarily crushed material SM may, for example, be stored in a heap of stones 58, or may be transported away for further crushing, grinding etc.

The jaw crusher 1 and the secondary crusher, in this example embodiment the gyratory crusher 40, form together a crushing system 60 in which the main task of the jaw crusher 1 is to act as a primary crusher that prepares the raw material RM for being crushed in the gyratory crusher 40, which performs the secondary crushing aiming at forming a useful material. The jaw crusher 1 is operated in such a manner that the primarily crushed material PM has a predictable and low maximum size, as will be described in more detail hereinafter. The maximum size of the primarily crushed material PM is a dimensioning factor for the gyratory crusher 40. The smaller the maximum size of the primarily crushed material PM the more narrow the width of the crushing chamber 52 of the gyratory crusher 40, and the more efficient the crushing of the material in the gyratory crusher 40. Hence, for example, the gyratory crusher 40 can be designed in a more efficient manner if the maximum largest size of the primarily crushed material PM is 150 mm, compared to a situation where the maximum largest size of the primarily crushed material PM is 300 mm. Furthermore, pieces of primarily crushed material PM that is substantially larger than intended may even block the crushing chamber 52 of the gyratory crusher 40 and result in stoppage of the production.

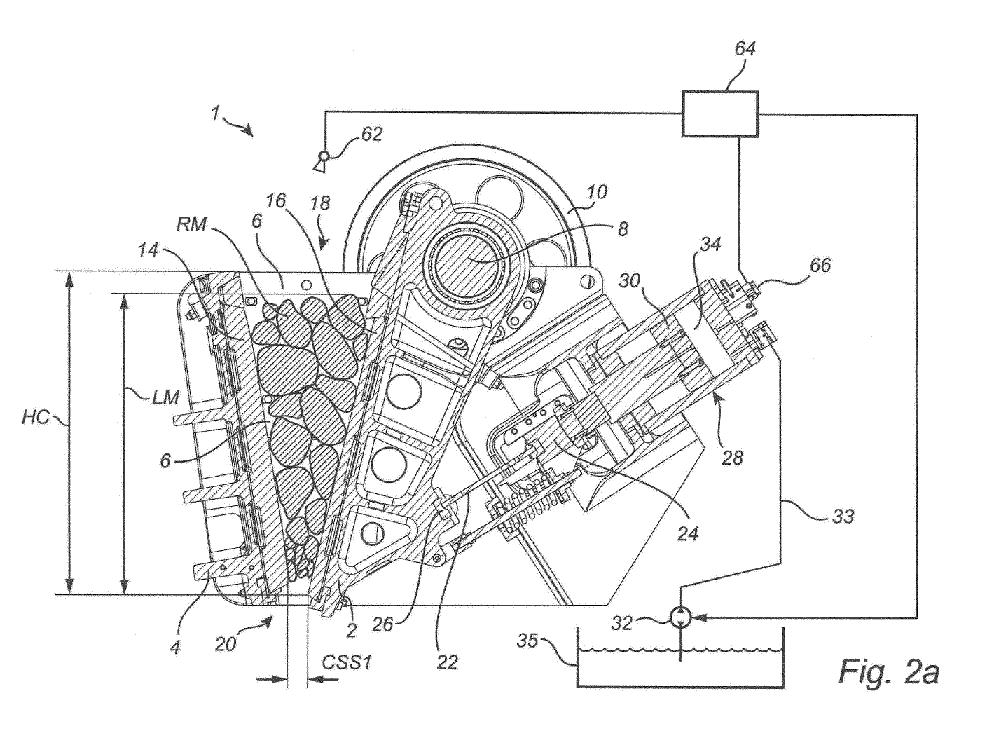

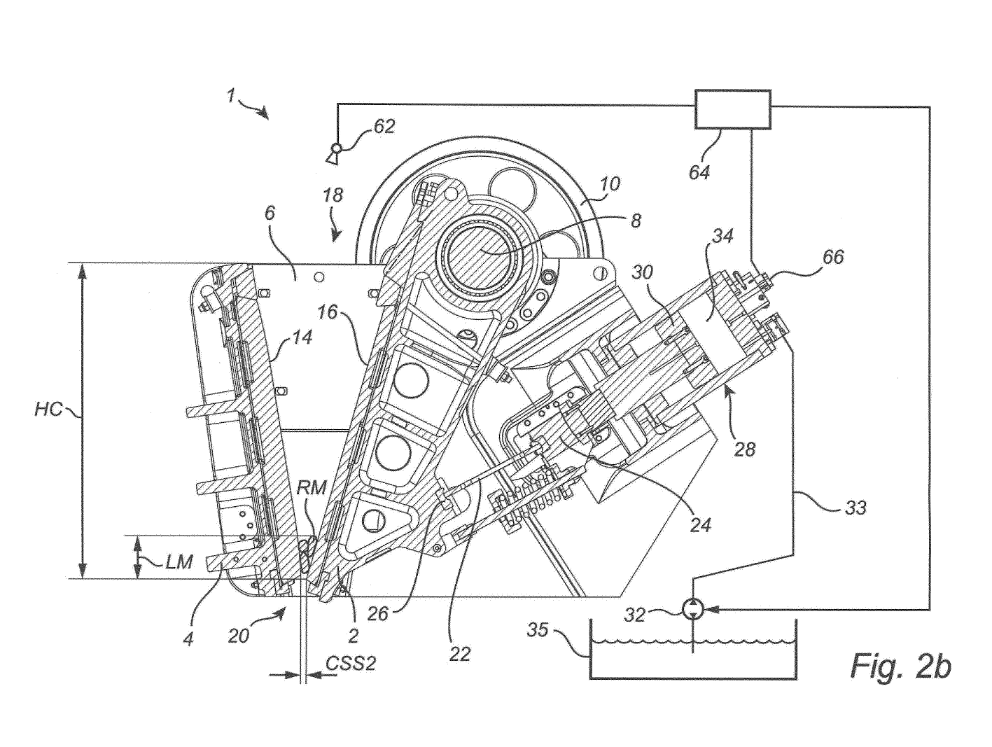

To this end, the jaw crusher 1 is provided with a crushing chamber level detector in the form of a crushing chamber level sensor 62. The crushing chamber level sensor 62 may, for example, be an ultrasonic sensor, or a radar sensor, and measures the present level of raw material RM in the crushing chamber 6 of the jaw crusher 1. The crushing chamber level sensor 62 is connected to a jaw crusher control system 64. The jaw crusher control system 64, which may, for example, be a process computer, is adapted to receive signals from the crushing chamber level sensor 62 and to control the hydraulic fluid pump 32 to pump hydraulic fluid to the hydraulic fluid cylinder 34, or pump hydraulic fluid from the hydraulic fluid cylinder 34, to obtain a suitable closed side setting, CSS, to ensure that the maximum largest size of the primarily crushed material PM is always below that maximum size for which the gyratory crusher 40 is designed. The manner of controlling the suitable closed side setting, CSS, will be explained in more detail with reference to FIGS. 2a and 2b.

FIG. 2a illustrates the jaw crusher 1 when operating at full capacity and FIG. 2b illustrates the jaw crusher 1 when operating at low capacity.

When the jaw crusher 1 operates at full capacity, as shown in FIG. 2a, the crushing chamber 6 is full of raw material RM to be crushed. When the crushing chamber 6 is full of material RM there will be a substantial autogenic crushing in the crushing chamber 6. By autogenic crushing is meant that not only will pieces of material be crushed by direct contact with the wear plates 14, 16, but crushing action will also occur as an effect of pieces of material being crushed by being contacted by, and squeezed between, other pieces of material. Due to the element of autogenic crushing in a crushing chamber 6 that is full of raw material RM, wherein pieces of material are crushed by being contacted with other pieces of material, the pieces of primarily crushed material PM leaving the jaw crusher 1 will have a substantially smaller size compared to the size that would be obtained by crushing under non-autogenic conditions at a similar first closed side setting CSS1. Furthermore, pieces of material having a non-spherical shape, for example elongate rod-like structures, will be efficiently crushed and made more round by the autogenic crushing. Hence, a first closed side setting CSS1, illustrated in FIG. 2a, of, for example, 100 mm would typically result in a primarily crushed material PM having a largest size of 150 mm. Hence, with a crushing chamber 6 that operates and is full of material the jaw crusher 1 produces, at a CSS1 of 100 mm, a primarily crushed material PM having a largest size of 150 mm, and the crushing chamber 52 of the downstream gyratory crusher 40, illustrated in FIG. 1, can be designed accordingly.

When the jaw crusher 1 is started, and when the feed of material to the jaw crusher 1 is stopped, either because it is intended to stop operation of the jaw crusher or because an unwanted stoppage has occurred in the feed of material, there will be little or no material in the crushing chamber 6. When the jaw crusher 1 operates with no material in the crushing chamber 6, or operates with very little material in the crushing chamber 6, as illustrated in FIG. 2b, there is no or little autogenic crushing. The result is that the crushing is less efficient and that large pieces of material can pass through the crushing chamber 6. For example, if the crushing chamber 6 is empty and the first piece of raw material RM that is fed to the empty crushing chamber 6 is a piece of rock having a rod like structure with a “diameter” of 150 mm and a “length” of 400 mm, then such piece could pass through the crushing chamber 6 without being crushed at all. The result would be that the piece of raw material RM having a length of 400 mm would pass uncrushed through the jaw crusher 1 and would be transported, via the conveyor 38, to the gyratory crusher 40, illustrated in FIG. 1. The gyratory crusher 40 would then have to be dimensioned for primarily crushed material PM with a maximum length of, for example, 500 mm. The result could be that a gyratory crusher of a larger size would be necessary to achieve the desired size of the secondarily crushed material SM. In order to reduce the above effects the jaw crusher control system 64 is adapted to control the closed side setting CSS of the jaw crusher 1 to obtain that setting which provides for the desired crushing effect depending on the amount of material that is present in the crushing chamber 6.

In FIG. 2a the crushing chamber level sensor 62 measures a level of raw material RM present in the crushing chamber 6. A signal corresponding to this level is sent to the jaw crusher control system 64 which interprets the signal as a “Full crushing chamber”. For example, if the crushing chamber 6 has a total height HC, then the crushing chamber 6 could be considered to be full as long as the level LM of raw material RM in the crushing chamber 6 is at least 40% of the total height HC. In the situation illustrated in FIG. 2a the level LM of raw material RM is about 95% of the total height HC and is, as such, interpreted as the crushing chamber 6 being full of material. Correspondingly, the jaw crusher control system 64 sends a signal to the hydraulic fluid pump 32 to pump hydraulic fluid to or from the hydraulic fluid cylinder 34 to obtain that first closed side setting CSS1 which is desired for operation with a full crushing chamber 6. For example, this first closed side setting CSS1 could be 100 mm. For example, a position sensor 66 may be arranged on the hydraulic positioning device 28 to sense the present position of the hydraulically controlled piston 30 to assist in setting the correct closed side setting CSS1.

In FIG. 2b the crushing chamber level sensor 62 measures a level of raw material RM present in the crushing chamber 6. A signal corresponding to this level is sent to the jaw crusher control system 64 which interprets the signal as an “Empty crushing chamber”. For example, the crushing chamber 6 could be considered to be empty if the level LM of raw material RM in the crushing chamber 6 is less than 40% of the total height HC of the crushing chamber 6. In the situation illustrated in FIG. 2b the level LM of raw material RM is about 15% of the total height HC and is, as such, interpreted as the crushing chamber 6 being empty of material. Correspondingly, the jaw crusher control system 64 sends a signal to the hydraulic fluid pump 32 to pump hydraulic fluid to or from the hydraulic fluid cylinder 34 to obtain that second closed side setting CSS2 which is desired for operation with an empty crushing chamber 6. This second closed side setting CSS2 is narrower than the first closed side setting CSS1 used when the crushing chamber 6 is full of material. Starting out from the situation illustrated in FIG. 2a, the pump 32 would pump hydraulic fluid to the cylinder 34 to force the movable jaw 2 towards the fixed jaw 4 to obtain the second closed side setting CSS2. For example, this second closed side setting CSS2 could be 50 mm. With a closed side setting CSS2 of only 50 mm the risk is substantially reduced that large objects pass through the crushing chamber 6 without being crushed. Thereby, the secondary treatment device, in this example embodiment the gyratory crusher 40 illustrated in FIG. 1, could be safely dimensioned for primarily crushed material PM having a maximum size of less than, for example, 150 mm, which makes the operation of the gyratory crusher 40 more efficient. Thereby, the complete crushing system 60, comprising the jaw crusher 1 and the secondary treatment device, for example the gyratory crusher 40, will work efficiently, and will be relatively insensitive to situations when the crushing chamber 6 of the jaw crusher 1 temporarily runs empty, or almost empty.

Hereinbefore it has been described that the crushing chamber level detector has the form of a crushing chamber level sensor 62 which measures, directly, how much raw material RM that is present in the crushing chamber 6 of the jaw crusher 1. However, the amount of raw material RM in the crushing chamber 6 can also be measured by other methods, in combination with or as alternative to the level sensor 62. In accordance with one alternative embodiment the control system 64 may receive a jaw crusher motor power signal from the jaw crusher motor 12, as illustrated in FIG. 1. Hence, in this alternative embodiment the motor 12 functions as the crushing chamber level detector which detects the amount of material that is present in the crushing chamber 6. The signal sent from the motor 12 to the control system 64 indicates the present power, in, for example, kW, drawn by the motor 12. The power drawn by the motor 12 is an indirect indication of the amount of raw material RM that is present in the crushing chamber 6, wherein a high power indicates a high level LM of raw material RM in the crushing chamber 6, and a low power indicates a low level LM of raw material RM in the crushing chamber 6. Hence, if the signal received by the control system 64 from the motor 12 indicates a high power, meaning a high level LM of raw material RM, the closed side setting could be set to the first closed side setting CSS1 illustrated in FIG. 2a, and if the signal received by the control system 64 from the motor 12 indicates a low power, meaning a low level LM of material RM, the closed side setting could be set to the second closed side setting CSS2 illustrated in FIG. 2b.

The control system 64 may, hence, use a signal from the level sensor 62 and/or the signal from the jaw crusher motor 12 to determine the amount of raw material RM that is present in the crushing chamber 6. When the control system 64 uses the signals from both the level sensor 62 and the jaw crusher motor 12 an extra safe and reliable measurement is obtained.

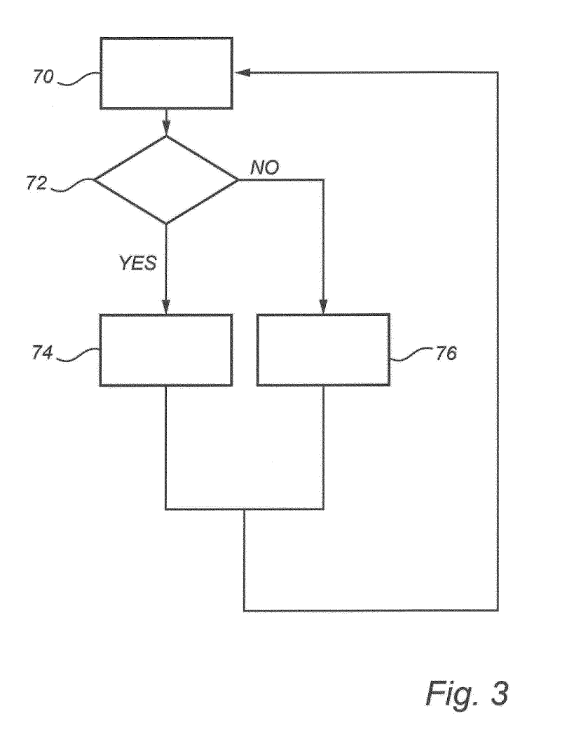

FIG. 3 is a schematic diagram illustrating the control principle employed by the jaw crusher control system 64 illustrated in FIGS. 1, 2a and 2b.

In a step 70 the level of material present in the crushing chamber 6 is measured by means of the level sensor 62 and/or the jaw crusher motor 12 as described hereinbefore.

In a step 72 the measured level is compared to at least one crushing chamber level set point to determine whether or not the measured level is equal to or higher than the set point, or if the measured level is lower than the set point. The at least one set point could, for example, be a level LM corresponding to about 40% of the total height HC of the crushing chamber 6. If the level measured in step 70 is equal to or higher than the set point, then the result of the comparison of step 72 is “YES”, and the control system 64 proceeds to step 74. If the level measured in step 70 is lower than the set point, then the result of the comparison of step 72 is “NO”, and the control system 64 proceeds to step 76.

In step 74 the control system 64 prepares the jaw crusher 1 for operation with a full crushing chamber 6. Hence, the control system 64 controls the pump 32 to adjust the closed side setting to the first closed side setting CSS1.

In step 76 the control system 64 prepares the jaw crusher 1 for operation with an empty crushing chamber 6. Hence, the control system 64 controls the pump 32 to adjust the closed side setting to the second closed side setting CSS2.

Thereafter, the control system 64 returns to step 70.

It will be appreciated that it is also possible, as an alternative embodiment, to utilize several different set-points. For example, the level LM of raw material RM could be compared to a first set point corresponding to 60% of the total height HC of the crushing chamber 6, and to a second set point corresponding to 20% of the total height HC of the crushing chamber 6. If the level LM is equal to or higher than the first set point, then the crushing chamber 6 is considered as “full” and the closed side setting is controlled to the first closed side setting CSS1, as illustrated in FIG. 2a. If the level LM is lower than the second set point, then the crushing chamber 6 is considered as “empty” and the closed side setting is controlled to the second closed side setting CSS2, as illustrated in FIG. 2b. Furthermore, if the level LM is lower than the first set point but equal to or higher than the second set point, then the closed side setting could be controlled to an intermediate third closed side setting CSS3, which is narrower than the first closed side setting CSS1, but is wider than the second closed side setting CSS2. For example, the first closed side setting CSS1 could be 100 mm, the second closed side setting CSS2 could be 50 mm, and the intermediate, third closed side setting CSS3 could be 75 mm.

It will be appreciated that it is also possible, as a still further alternative embodiment, to utilize an equation according to which the hydraulic device 28 gradually widens the closed side setting from the second closed side setting CSS2 to the first closed side setting CSS1 as the amount of material in the crushing chamber 6 increases. Hence, the control system 64 could control the position of the movable jaw 2 depending on the level LM of material RM in the crushing chamber 6 to achieve a suitable closed side setting CSS based on the following equation:

CSS=CSS2+level LM*Factor K

The factor K is selected to obtain a closed side setting CSS which is equal to the first closed side setting CSS1 when the level LM of material RM is 100% of the total height HC of the crushing chamber 6. It will be appreciated that other equations could also be used for controlling the closed side setting gradually based on the measured amount of material in the crushing chamber 6.

In addition to adjusting the closed side setting CSS depending on the amount of material that is present in the crushing chamber 6 as described above, the hydraulic positioning device 28 may be used for adjusting the position of the movable jaw 2 taking into account also other factors. For instance, the adjustment of the position of the movable jaw 2 may also involve a compensation for wear of the wear plates 14, 16 against which material is crushed. Furthermore, the hydraulic positioning device 28 may also be used for adjusting the position of the movable jaw 2 to adapt the jaw crusher 1 for crushing various types of materials, and to obtain various average sizes of the crushed material, meaning that different sets of first and second closed side settings CSS1 and CSS2 may be used depending on the material to be crushed.

It will be appreciated that numerous modifications of the embodiments described above are possible within the scope of the appended claims.

Hereinbefore it has been described that the secondary crusher, which acts on and further crushes a material that has previously been crushed in the jaw crusher 1 in its function of being a primary crusher, may be a gyratory crusher 40. It will be appreciated that also other types of crushers could be utilized as a secondary crusher. Examples of such other types of crushers include horizontal shaft impact (HSI) crushers, vertical shaft impact (VSI) crushers, autogenous and semiautogenous mills, including ball mills, rod mills, etc. Also such types of secondary crushers are designed for a certain maximum size of the material fed thereto, and advantages are obtained by the present jaw crusher 1, since the maximum size of the material for which such secondary crusher is designed may be reduced.

Still further, another type of secondary treatment device could be arranged downstream of the jaw crusher 1 functioning as a primary crusher. For example, a secondary treatment device in the form of a sieve could be arranged downstream of the jaw crusher 1 to classify the primarily crushed material PM leaving the jaw crusher 1. Also such a sieve is designed based on the maximum size of the material entering the sieve, and can be designed more efficiently when combined with the present jaw crusher 1 producing a material with a reduced maximum material size.

To summarize, a jaw crusher control system (64) is adapted for controlling a hydraulic positioning device (28) positioning a movable jaw (2) of a jaw crusher (1) of the type comprising a movable jaw (2) and a stationary jaw (4) forming between them a variable crushing chamber (6). The jaw crusher control system (64) is adapted to receive a signal from a crushing chamber level detector (62, 12) indicating the amount of material that is present in the crushing chamber (6) and to control the hydraulic positioning device (28) to position the movable jaw (2) to obtain a first closed side setting (CSS1) when the crushing chamber (6) is considered as full of material, and to obtain a second closed side setting (CSS2) when the crushing chamber (6) is considered as empty of material, wherein the second closed side setting (CSS2) is more narrow than the first closed side setting (CSS1).

1. A jaw crusher control system for controlling a hydraulic positioning device arranged for positioning a movable jaw of a jaw crusher of the type having a movable jaw and a stationary jaw forming between them an outlet of a variable crushing chamber, the jaw crusher control system comprising a processor arranged to receive a signal from a crushing chamber level detector that indicates an amount of material that is present in the crushing chamber and to control the hydraulic positioning device to position the movable jaw to obtain a first closed side setting when the crushing chamber is considered as full of material, and to obtain a second closed side setting when the crushing chamber is considered as empty of material, wherein in the second closed side setting the outlet is more narrow than in the first closed side setting.

2. A jaw crusher control system according to claim 1, wherein the processor is arranged to compare the signal received from the crushing chamber level detector to a crushing chamber level set point and to determine, based on said comparison, whether the crushing chamber is to be considered as full or empty of material.

3. A jaw crusher control system according to claim 1, wherein the crushing chamber level detector is a level sensor (62).

4. A jaw crusher control system according to claim 1, wherein the crushing chamber level detector is a signal from a jaw crusher motor.

5. A jaw crusher control system according to claim 1, wherein the processor is arranged to control the hydraulic positioning device to position the movable jaw to the first or second closed side setting during operation of the jaw crusher.

6. A jaw crusher comprising:
a movable jaw and a stationary jaw forming between them an outlet of a variable crushing chamber;
a hydraulic positioning device arranged to positioning the movable jaw with respect to the stationary jaw; and
a jaw crusher control system including a processor arranged to receive a crushing chamber level detector that indicates an amount of material that is present in the crushing chamber and to control the hydraulic positioning device to position the movable jaw to obtain a first closed side setting when the crushing chamber is considered as full of material, and to obtain a second closed side setting when the crushing chamber is considered as empty of material, wherein in the second closed side setting the outlet is more narrow than in the first closed side setting.

7. A crushing system, comprising:
a jaw crusher according to claim 6;
a secondary treatment device; and
a transporting device arranged to transport material that has been crushed in the jaw crusher to the secondary treatment device for being further treated.

8. A method of crushing material, comprising the steps of:
measuring an amount of material that is present in a crushing chamber of a jaw crusher, the jaw crusher having a stationary jaw and a movable jaw, the stationary and movable jaw forming an outlet therebeteen in the crushing chamber;
determining whether the crushing chamber of the jaw crusher is to be considered as full or empty with material to be crushed;
controlling, when the crushing chamber has been determined to be considered as full, the position of the movable jaw of the jaw crusher to obtain a first closed side setting; and
controlling, when the crushing chamber has been determined to be considered as empty, the position of the movable jaw of the jaw crusher to obtain a second closed side setting, wherein in the second closed side setting the outlet is more narrow than in the first closed side setting.

9. A method according to claim 8, further comprising measuring a level of material present in the crushing chamber with a level sensor.

10. A method according to claim 8, further comprising measuring a level of material present in the crushing chamber by measuring the power drawn by a jaw crusher motor.

11. A method according to claim 8, further comprising determining whether the crushing chamber of the jaw crusher is considered as full or empty with material to be crushed by comparing the measured amount of material present in the crushing chamber of the jaw crusher to a first set point, wherein the crushing chamber is considered to be full if the measured amount of material is higher than the first set point, and the crushing chamber is considered to be empty if the measured amount of material is lower than the first set point.

12. A method according to claim 8, wherein the measured amount of material in the crushing chamber of the jaw crusher is compared to a first set point and to a second set point, wherein, if the measured amount of material is higher than the first set point, the crushing chamber is considered as full and the closed side setting is controlled to the first closed side setting, if the measured amount of material is lower than the second set point, then the crushing chamber is considered as empty and the closed side setting is controlled to the second closed side setting, and if the measured amount of material is lower than the first set point but higher than the second set point, then the closed side setting is controlled to an intermediate third closed side setting, wherein the outlet is narrower than in the first closed side setting, but wider than when in the second closed side setting.

13. A method according to claim 8, wherein the controlling of the position of the movable jaw of the jaw crusher to obtain the first or the second closed side setting is performed automatically and during operation of the jaw crusher.

14. A method according to claim 8, wherein in the closed side setting the outlet of the crushing chamber is controlled to be gradually widened in relation to an increasing amount of material present in the crushing chamber.

15. A method according to claim 8, wherein the crushing chamber of the jaw crusher is considered to be empty if the amount of material in the crushing chamber corresponds to a level of material in the crushing chamber which is less than 40%, and at least if the level is less than 20%, of the total height of the crushing chamber, and/or wherein the crushing chamber of the jaw crusher is considered to be full if the amount of material in the crushing chamber corresponds to a level of material in the crushing chamber which is equal to or more than 40%, and at least if the level is more than 60%, of the total height of the crushing chamber.
